(19) United States
(12) Patent Application Publication
(10) Pub. No.: US 2013/0087294 A1
(43) Pub. Date: Apr. 11, 2013

(54) Window Blinds with Flippable Overlapping Slats

(71) Applicant: Sassan Khajavi, Beverly Hills, CA (US)

(72) Inventor: Sassan Khajavi, Beverly Hills, CA (US)

(21) Appl. No.: 13/555,031

(22) Filed: Jul. 20, 2012

Related U.S. Application Data
(60) Provisional application No. 61/510,040, filed on Jul. 20, 2011.

(51) Int. Cl. E06B 9/28

(52) U.S. Cl. CPC E06B 9/28
USPC 160/174 R; 160/405

(57) ABSTRACT

An energy-saving vertical or horizontal window blind offers two levels of light for any slat angle. Additionally, the blind cools the room when closed without creating glare when open. The blind slats rotate 360 degrees, and flip and rotate 180 degrees from any angle. The slats have two sides that are optically different. They are more reflective on one side, and less reflective on the other side. The 180 degree or 360 degree rotation takes place despite the blind slats overlapping each other. The overcoming of overlap is achieved by use of slats that are made of bendable and flexible material at the longitudinal edge, where they overlap. One side of the slats could have grooves running longitudinally along the axis of slats. These grooves can either have a reflective surface or be non-reflective.

This application claims the benefit of U.S. Provisional Patent Application 61/510,040 with filing date of Jul. 20, 2011.

### BACKGROUND OF THE INVENTION

1. Field of Invention

This invention is a window or skylight Venetian or vertical blind or shutter. The invention is used in commercial and residential buildings. It is the only blind that when open, could have both of its slats sides face the sun, thus bringing into the room two levels of light. The blind slats have overlap to provide privacy, prevent light seeping through, thus keeping the room cool, and to minimize conductive heat loss at night.

2. Prior Art

A patent was filed on Jun. 30, 2004 with application Ser. No. 10/993,280. This application discloses window blind that have overlap and flip and have different optical surfaces. However, no simple method of overcoming the overlap between the slats was disclosed. For example, to overcome the overlap of slats, a method was disclosed, whereby, first the odd number slats rotate, and then the even number slats rotate. This method if done manually requires twice as much cord to control odd and even slats separately.

No other prior art exists that satisfies all three requirements that make the essence of this invention. Namely, slats that flip when open, slats that are reflective on one side and non-reflective on the other, and slats that have overlap, and slats that easily overcome the overlap to flip.

### SUMMARY OF THE INVENTION

The object of this invention is to provide a blind that has both architectural advantage and an energy-saving advantage. From an architectural and interior decoration point of view, the disclosed blind provides the advantage of providing two levels of light for any slat angle. A different way to state this is that this blind makes it possible to reduce light coming into a room, without reducing the view of the outside. From an energy-saving point of view, the disclosed window blind reflects solar energy outward when closed, but does not reflect this solar energy deep into the room when it's open.

### MERITS OF THE INVENTION

Almost five percent of the United States energy consumption is due to unwanted heat gain or heat loss though windows of office buildings and residential buildings. This invention will substantially lower this energy loss in summer and sunny times.

The disclosed blind saves up to 200 Watts per square meter of glass, when closed.

The invention is simple and can be made by slight modification to ordinary vertical blinds. It is thus not a costly invention and one of the merits is that it is about the same price as other regular blinds in the market.

The disclosed invention is the only blind that provides two levels of light per slat angle, and reduces light without reducing the view. And the only blind that cools the room when closed or partially closed, but does not reflect light, glare, and heat inside the room when it is open.

### DESCRIPTION OF DRAWINGS

FIG. 1 is an end view of a window glass 3 and end view of three blind slats 1. Sun's incoming rays are shown going through the glass and getting reflected off the surface of the slat. The slats have two surfaces. In this figure, the upper surface is more reflective than the lower surface.

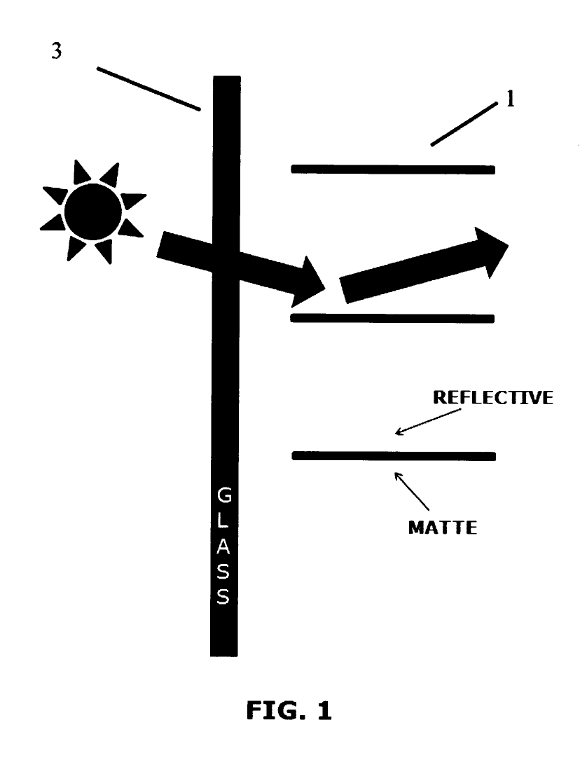

FIG. 2 is an end view of a window glass and end view of three ordinary blind slats. Sun's incoming rays are shown going through the glass and getting reflected off the surface of the slat. The slats have two surfaces. In this figure, the bottom surface is more reflective than the upper surface.

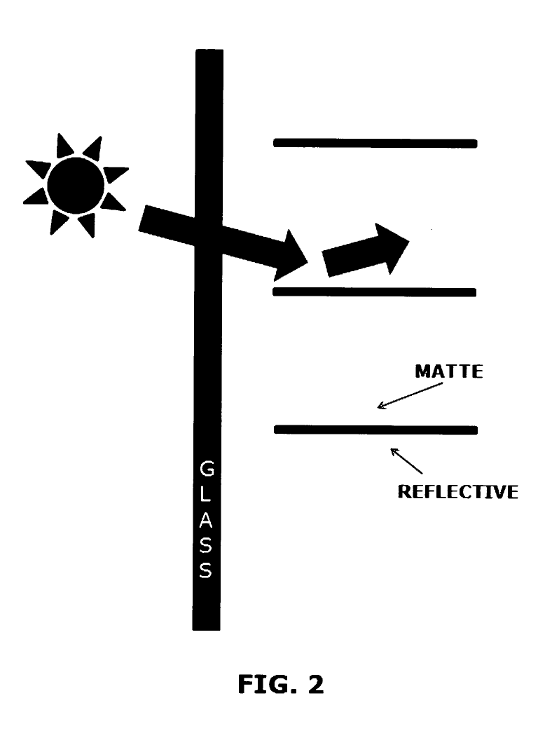

FIG. 3 is an end view of a window glass and end view of three blind slats. The slats have been rotated counter clock wise to show that they cannot rotate 180 degrees from open position due to the overlap 5 shown.

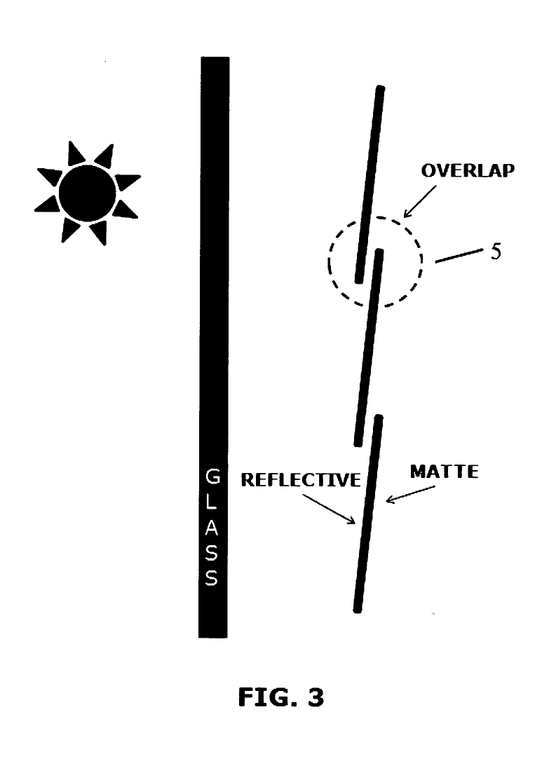

FIG. 4 is an end view of a window glass and end view of three blind slats. The slats have been rotated clock wise to show that they cannot rotate 180 degrees from open position due to the overlap 5 shown.

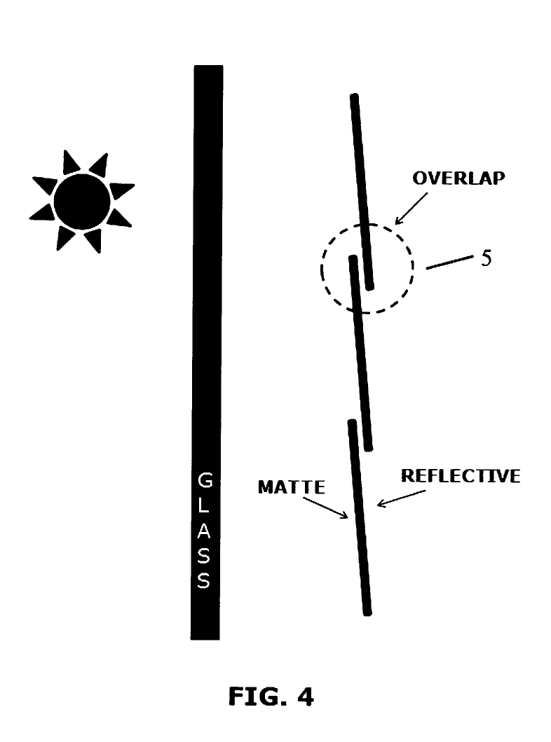

FIG. 5 is an end view of one of the embodiments of this invention. The figure shows a slat 11 end-view. One of the longitudinal edges 9 of the slat is flexible and is capable of being bent.

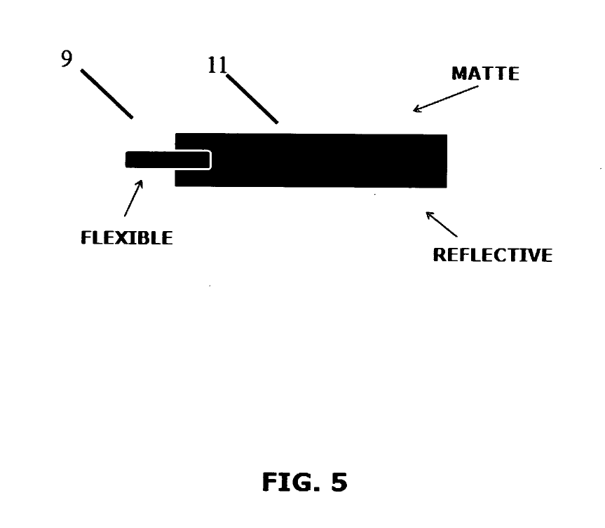

FIG. 6 is an end view of a blind slat 15 as one of the embodiments of this invention. The figure shows end view of a slat and that two of the longitudinal edges 13 of the slat is flexible and is capable of being bent. One surface is more reflective than the other.

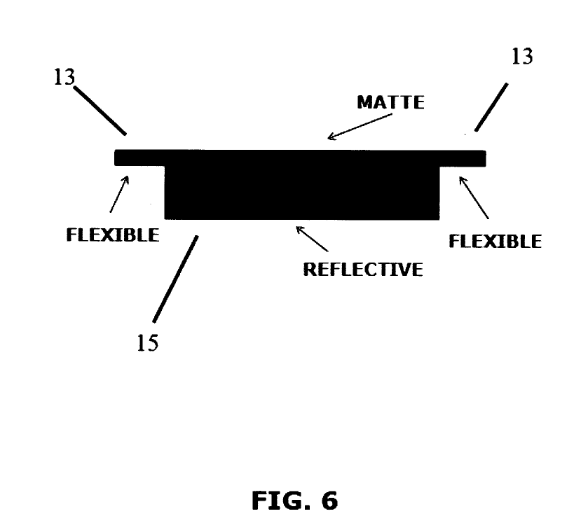

FIG. 7 is the end view of a slat 17 that is entirely flexible and bendable. This type of slat could be made with a thin fabric, for example.

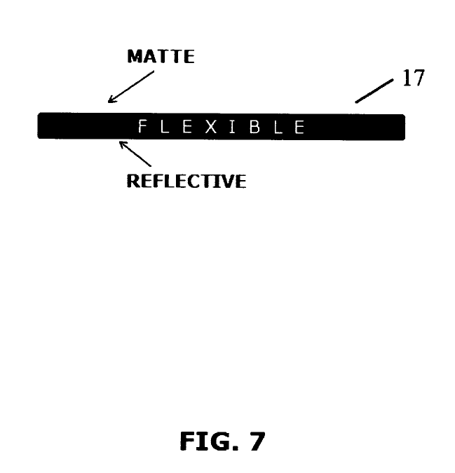

FIG. 8 is the end-view of a slat that is flexible and has on one surface grooves 19 running longitudinally that are the shape of isosceles triangles. In this embodiment, the surface of the surface grooves 19 is non-reflective.

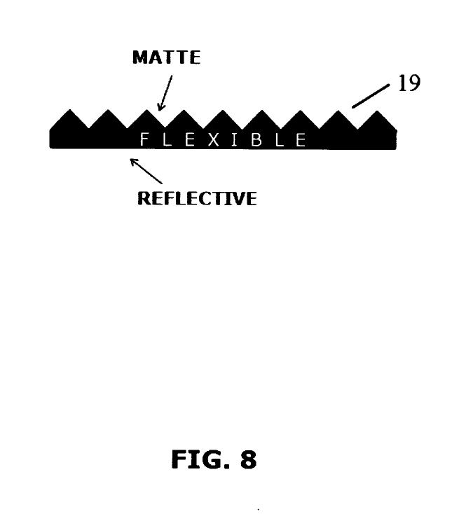

FIG. 9 is the end-view of a slat that is flexible and has on one surface grooves running longitudinally that are the shape of isosceles triangles. In this embodiment the surface of the triangles 19 is reflective.

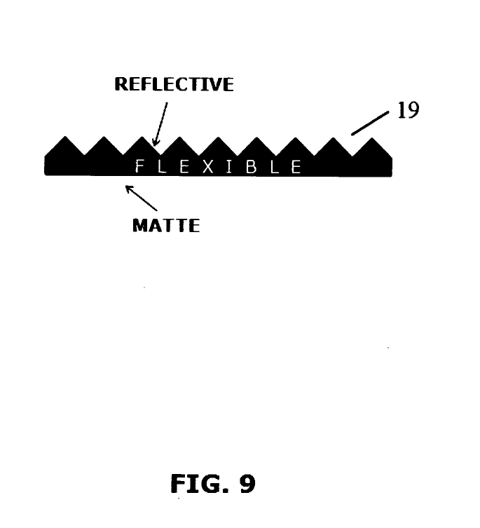

FIG. 10 is the end-view of a slat that is flexible and has on one surface grooves running longitudinally that are the shape of isosceles triangles. The surface of the triangles 19 is reflective. The opposite surface is also reflective.

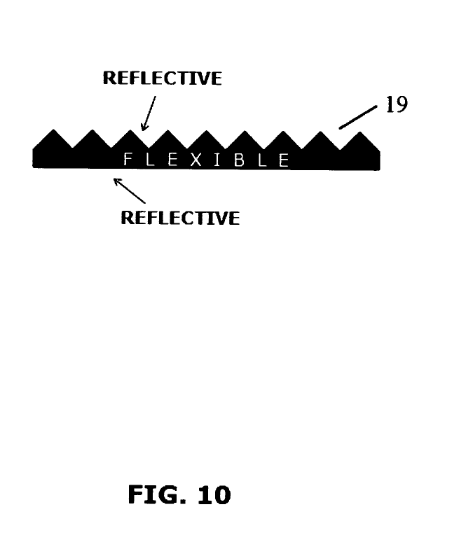

FIG. 11 is end view of a window glass and end view of three slats with grooves on top. The reflective grooves reflect the solar rays out 27 as shown, thus keeping the room cool.

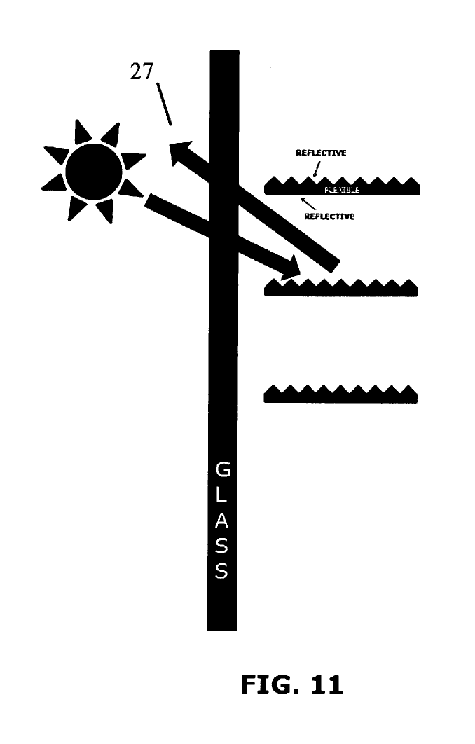

FIG. 12 is end view of a window glass and end view of three slats with grooves on bottom. The reflective flat top surface reflects the solar rays 29 towards the inside as shown, thus providing more light to inside of the room.

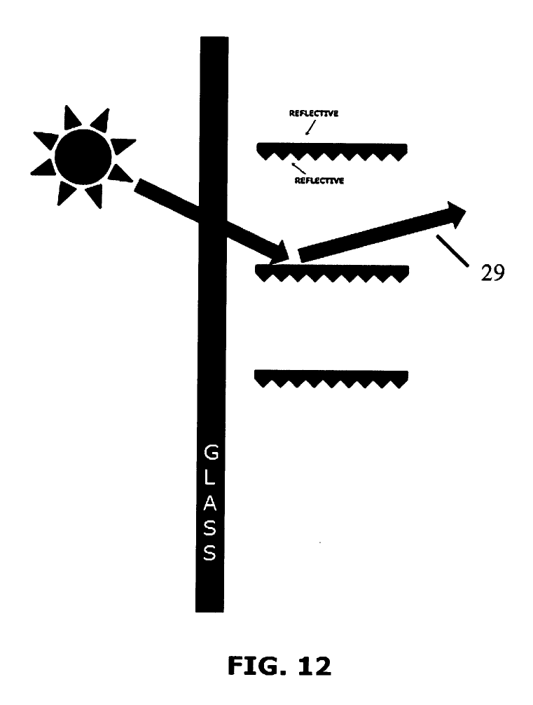

FIG. 13 is a front view of a single vertical blind slat 35 hanging from a rail. The slat is entirely made of a flexible material. At the connection point of slat to a rail 31 is a relatively inflexible material 33.

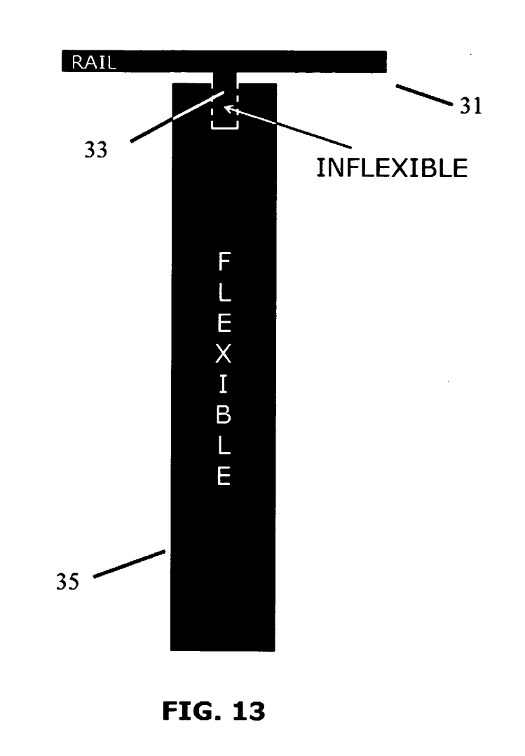

FIG. 14 is a front view of a single blind slat connected at both ends to rail 37 and rail 31. The slat is entirely made of a flexible material. This arrangement is for horizontal blinds that need support at both ends. The connection point of the slat to the rail is made of an inflexible material.

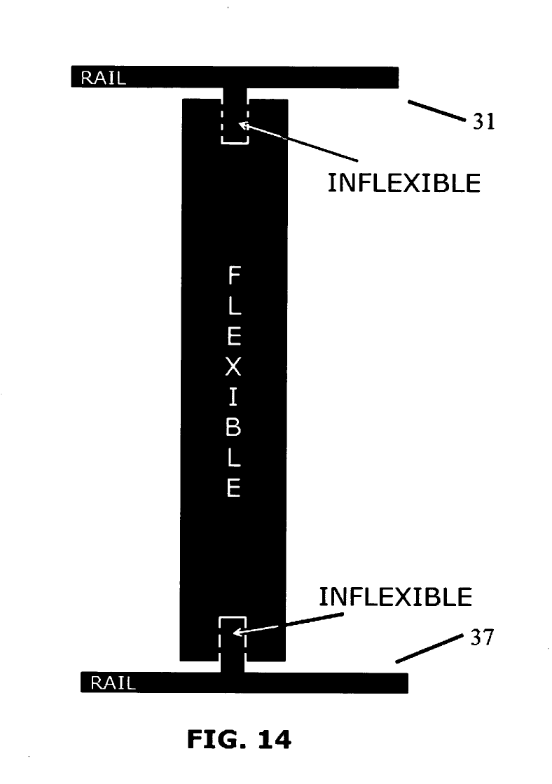

FIG. 15 is front view of three blind slats 35 in closed position hung from a rail. The figure shows that the slats when in closed position have overlap 41. The attachment 39 of the rail to the wall is also shown. The flexible slats are attached to the rail through an inflexible material 33.

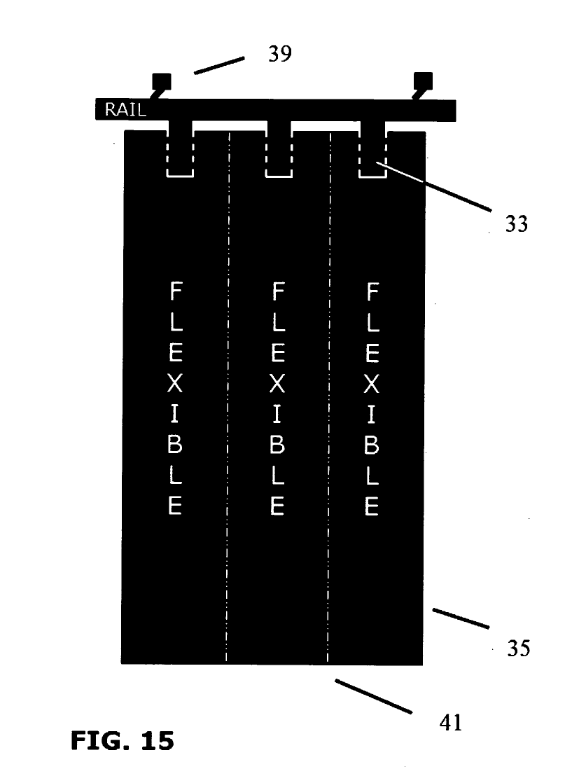

FIG. 16 is end view of the vertical blind rail 31. The rail is a gear with the gear's teeth running longitudinally.

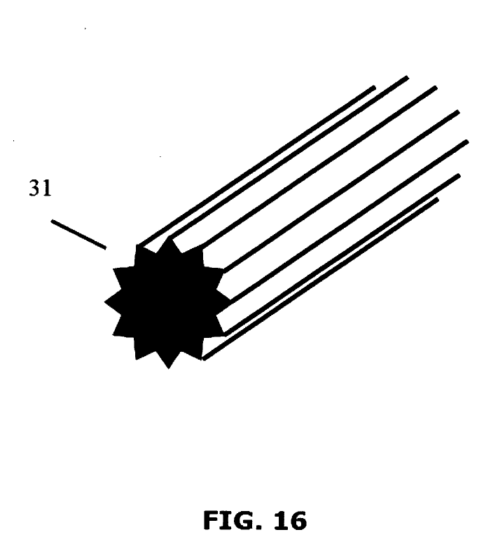

FIG. 17 is a cord shows a cord chain 43 that engages the teeth of the vertical blind bar 31. When one of the cord's ends is pulled downward the vertical blind bar rotates.

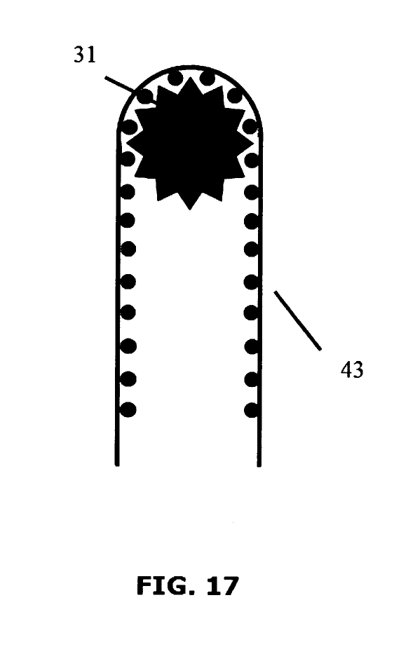

FIG. 18 is blind rail 31 and a second rail underneath the vertical blind rail. When one end of the cord 43 is pulled the blind rail 31 rotates. The gears 45 of the lower rail are shown separate from the upper blind rail, but in actuality, the gears of the lower rail are engaged to the teeth of the vertical blind rail. As the vertical blind rail rotates, the three gears shown rotate in a plane 90 degrees to the plane of rotation of the upper blind rail's rotation plane. The upper rail is attached to the wall through connection 39 and the lower rail is attached to the wall through connection 47.

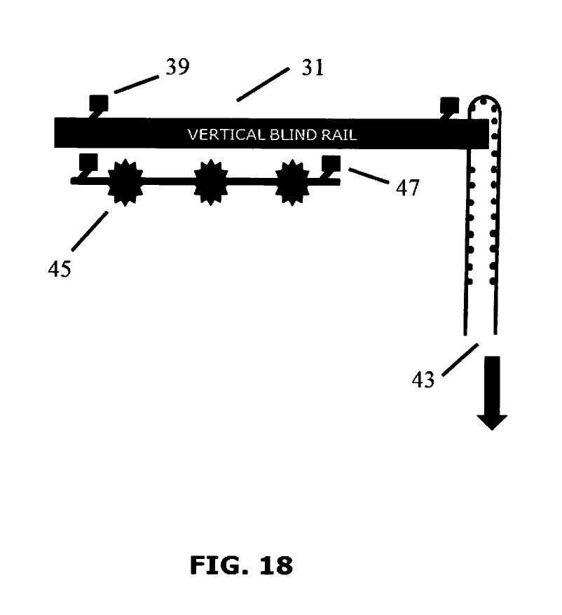

FIG. 19 is the entire mechanism that supports and rotates the vertical blind slats. As the cord 43 is pulled at one end, the blind rail 31 rotates, making the lower gears 45 rotate, and the lower gears engage the gears 53 directly attached to the vertical blind slats, making them rotate. The slats can rotate 360 degrees or a full 180 degrees from one open position to the another open position. It should be noted that this is simply for demonstration. This arrangement obviously does not allow for the blind to be drawn. This arrangement is only intended to show that when flexible slats are rotated, they will overcome the overlap because the entire slat and thus its edges are flexible. The ideal way to implement the effect shown in this drawing is through a simple modification of a regular carrier of a regular vertical blind. The modification would be to remove the stop mechanism that stops the carrier gear to rotate 360 degrees.

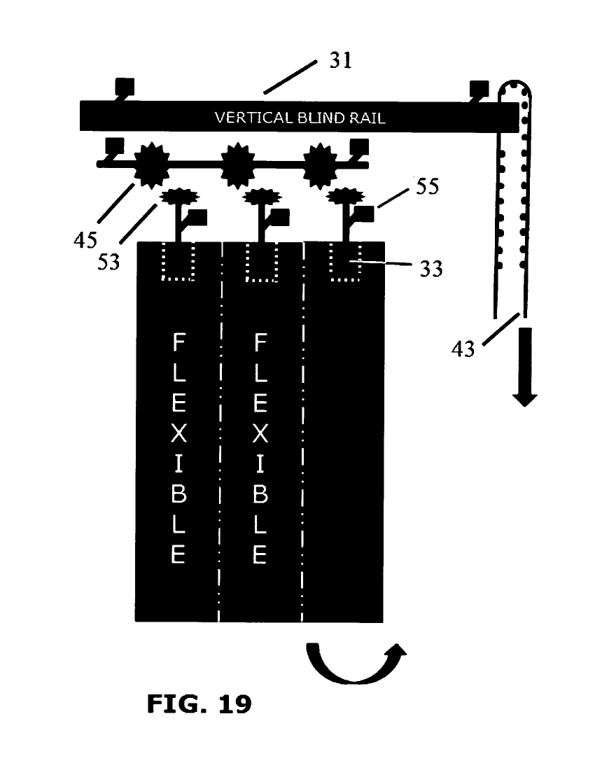

FIG. 20 is end view of blinds in a closed position such that no light will get inside the room at their edges. The reflective side of slats faces the sun, thus most of sun's rays will be reflected towards the outside, as shown.

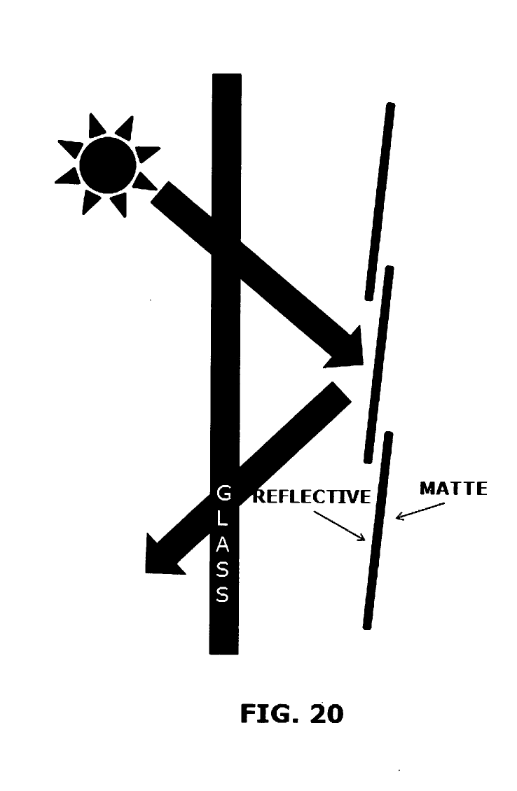

FIG. 21 is end view of blinds in a closed position such that no light will get inside the room at their edges. The blind slats are shown to rotate in clockwise direction.

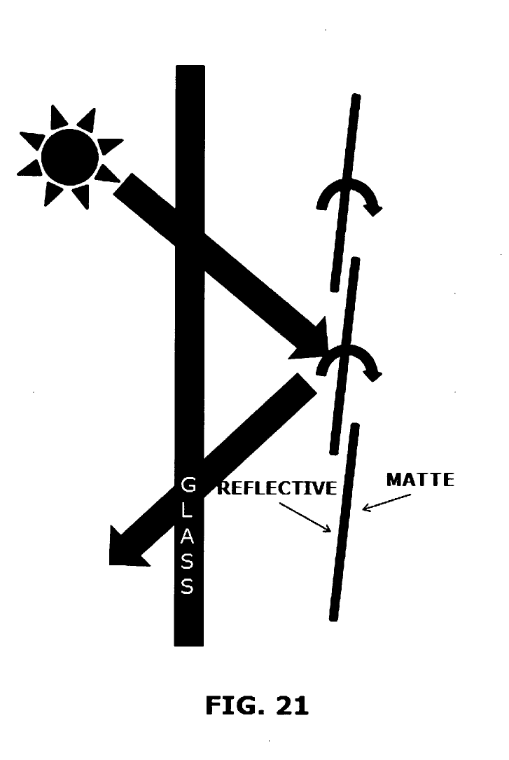

FIG. 22 is an end view of a window glass and end view of three blind slats. The slats have been rotated counter clock wise to the open position. The problem shown here is that the heat is reflected inside by the reflective surface.

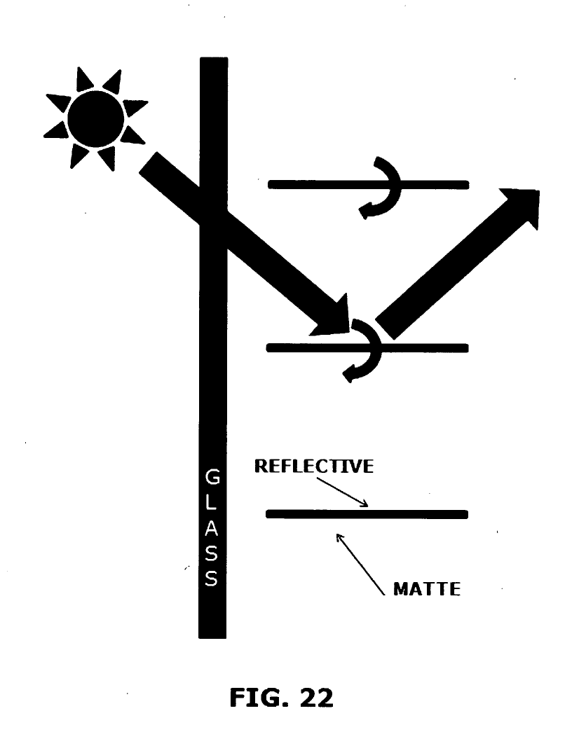

FIG. 23 is an end view of a window glass and end view of three blind slats. The slats have been rotated an additional 180 degrees in the counter clock wise direction so that the matte surface faces the sun. In this position less heat is reflected inside the room.

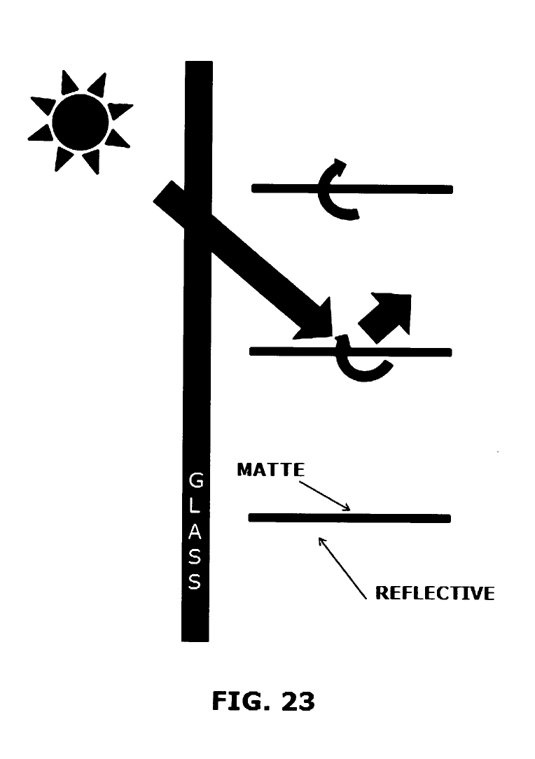

### DESCRIPTION OF THE PREFERRED EMBODIMENTS OF THE INVENTION

The edges of slats bend to allow the slat slip past each other and flip. Best example of flipping is considering the blind when the slats are fully open allowing full view of the outside. Regular blinds do not allow the user to flip the slats in this position. For example, if the sun is shining on the upper surface when slats are in the fully open position, the regular blinds cannot be rotated to have the sun shine on the opposite surface and still be in the fully open position.

The blind disclosed in this invention could be implemented with any type of blind made with slats. For example, a horizontal shutter could be made with slats that have bendable rubber at their edges. If the slats could then be rotated a full 180 degrees from open position to open position the rubber edges bend and allow the slats to slide passed each other. One can use rubber like the kind and with the thickness of rubber of typical car windshield wipers, for example.

One of the important improvements and advantageous of this blind is that it can reflect light out when closed, without reflecting light in, when open. The method of going from a closed position with the edge of slats close to the window tilted down, to a position whereby the non-reflective side of slat faces the sun, is an essence of this invention. This is a method easily implemented with an electronic remote control. If the closed button is pushed, the blind slats close to a position whereby the edge of slats closest to the glass, or the forward edge of the slats is tilted away from the sun, and when a button is pressed that says open, the blind computer knows to open the blind so that instead of reflective side facing the sun the non-reflective side faces the sun. This way, solar rays are reflected out when the blind is closed, but not reflected inside the room when the blind changes position to open, and maximum view is also provided.

This invention can also be used in skylights and for blinds that are used either inside a building, or outside the building or in between glass panes of windows.

Herein disclosed is the idea of implementing grooves on the slats of a blind using fabric technology. Fabric like corduroy can be used to either prevent light coming in or to prevent light and also reflect light out. This will create a blind that reduces light when open if the groove surfaces faces the sun and also reflects solar energy out of the building.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A window blind offering the ability to reduce light without reducing the view, comprising:
a. Slats that have different level of reflectivity to solar radiation on each of their side.
b. Slats that overlap when closed.
c. Means for rotating the slats at least 180 degrees to flip the slats, when the blind slats are in any open position.
d. Said slats having at least one bendable edge portion, said edge being longitudinal Whereby upon force of rotation, the flexible overlapping edges glide pass each other allowing for flipping or 360 degree rotation.

2. The method of flipping the slats when the slats are in open position, to expose different sides of the slat to outside light, which results in increasing or reducing light coming into a room, without any change in available view to occupants.

3. A window blind as in claim 1, whereby fabric slats that have flat surface on one side and grooved surface on the other side, whereby the grooves were create by texture on surface of fabric.

4. The method of changing the position of blind slats when the blind is closed, with the forward edge close to the window tilted down, and reflective side facing the sun; to the position of the slats being open, but the non-reflective side faces the sun.
